(19) United States
(12) Patent Application Publication
(10) Pub. No.: US 2014/0351126 A1
(43) Pub. Date: Nov. 27, 2014

(54) SECURE SYNCHRONIZATION OF PAYMENT ACCOUNTS TO THIRD-PARTY APPLICATIONS OR WEBSITES

(71) Applicant: Seth Priebatsch, Boston, MA (US)

(72) Inventor: Seth Priebatsch, Boston, MA (US)

(21) Appl. No.: 13/899,760

(22) Filed: May 22, 2013

(51) Int. Cl. G06Q 20/40

(52) U.S. Cl. CPC G06Q 20/40
USPC 705/44

(57) ABSTRACT

A two-factor approach for authenticating payment transactions between a third-party application and a consumer is facilitated by a transaction server via a consumer's mobile device. A first communication channel (e.g., the Internet) is used to request authorization, and a second independent communication channel is used for identity verification and authorization. The second channel is typically the user's mobile phone or other wireless communication device. In this way, authorization is de-linked from, but “synchronized” with, the communication channel used to purchase goods or services.

### BACKGROUND

E-commerce payment processors, such as PAYPAL and GOOGLE WALLET, have historically enabled third-party sites (e.g., online vendors, auctions sites, and other merchant systems) to complete transactions by having the consumer designate a payment method and enter credentials via the third party's site. A secure protocol such as OAUTH redirects the credentials to a payment processor and, upon authorization by the payment processor, passes back a secure credential to the site evidencing the approval. Funds are transferred from the consumer's designated account to the third-party site.

When a user enters credentials on the third-party site, however, many opportunities for identity theft are opened. Thieves can use a consumer's online activity to spread viruses, such as key loggers, onto the consumer's computer to transit back to themselves any passwords, usernames and other secure information used on the computer. Additionally, many online businesses today also store on their servers personal and financial information about consumers so that they may conveniently make subsequent purchases. This provides another target for identity thieves.

Accordingly, a secure but conveniently used system for conducting electronic payments that does not require transmission of secure information, such as a password, through a third party is needed. Additionally, an approach that extends these capabilities to consumers purchasing at a point-of-service, rather than online, is also needed.

### SUMMARY

The present approach addresses these problems by utilizing a second independent communication channel for identity verification and authorization. The second channel is typically the user's mobile phone or other wireless communication device. In this way, authorization is de-linked from, but “synchronized” with, the communication channel used to purchase goods or services. The approach of the present invention can also be extended to in-person purchases.

For example, in one representative Internet scenario, a customer visits a vendor's website and selects items for purchase. The customer selects a mobile payment option in accordance herewith; the vendor site thereupon sends a request for approval to a mobile payment server, which communicates with customer's mobile device, requesting approval of the transaction. The customer manifests approval by, e.g., touching an “approval” button displayed on the phone; an application running on the phone executes a script that confirms the customer's selection of the approval button as well as information authenticating the phone using the public telecommunications infrastructure. The mobile payment server communicates approval to the vendor, which completes the purchase.

In another representative scenario, the transaction occurs at a point-of-sale (POS) payment terminal at a “brick-and-mortar” store. The POS terminal offers the customer the choice of selecting debit card swipe, credit card swipe, or mobile payment. If the customer selects mobile payment, the payment terminal sends a request for approval to the mobile payment server, which thereupon communicates with the customer's phone using the public telecommunications infrastructure, requesting approval. Once again the customer manifests approval, which the phone communicates to the mobile payment server with along with appropriate authentication information. The mobile payment server thereupon communicates approval to the POS terminal via any suitable communication medium (web data transfer, text, telecommunications, etc.).

Accordingly, in one aspect, the invention pertains to a method of authorizing a payment transaction among a consumer, a merchant, and a registered consumer device by a transaction server. In representative embodiments, the method includes transmitting, by a merchant system to the transaction server over a first communication channel, a transaction-authorization request containing a consumer identifier; subsequent to the communication from the merchant system, transmitting the transaction authorization request to the registered consumer device over a second communication channel different from the first communication channel; and upon receiving over the second communication channel a transaction authorization granted by the consumer via the registered device, transmitting the transaction authorization to the merchant system over the first communication channel. The transaction authorization may include permission for a single payment transaction with the merchant. In various embodiments, the transaction authorization includes permission to process a plurality of payment transactions with the merchant. Additionally, the permission may be for only transactions meeting at least one criterion defined by the consumer. In various embodiments, the transaction authorization is in the form of a token. The consumer identifier may be an email address or a phone number.

In various embodiments, the method further includes storing the transaction authorization in a first transaction with the consumer for authorization in a subsequent transaction with the consumer. Additionally, the method may include modifying the transaction authorization via the registered consumer device in communication with the transaction server over the second communication channel; and transmitting, by the transaction server, the modified authorization to the merchant system over the first communication channel. In various embodiments, the first communication channel is the Internet and the second communication channel is a wireless telephone connection.

In another aspect, the invention relates to a transaction server for authorizing a payment transaction among a consumer, a merchant, and a registered consumer device. In various embodiments the transaction server includes a first interface for communicating over a first communication channel for receiving, from a merchant server, a transaction authorization request containing a consumer identifier; a second interface for communicating over a second communication channel different from the first communication channel; and a processor configured to (i) transmit the transaction authorization request to the registered consumer device over the second communication channel via the second interface, and (ii) transmit the transaction authorization to the merchant system over the first communication channel via the first interface upon receiving, over the second communication channel via the second interface, a transaction authorization granted by the consumer via the registered consumer device. The transaction authorization may include permission for a single payment transaction with the merchant. In various embodiments, the transaction authorization includes permission to process subsequent payment transactions with the merchant.

In various embodiments, the transaction server further includes a permissions database for storing consumer permissions, the permission to process subsequent payment transactions with the merchant being application only to transactions meeting criteria defined by the consumer and stored in a record of the database. The first communication channel may be the Internet and the second communication channel may be a wireless telephone connection.

As used herein, the term “mobile device” refers to a “smart phone” or tablet with advanced computing ability that, generally, facilitates bi-directional communication and data transfer using a mobile telecommunication network, and is capable of executing locally stored applications and/or payment transactions. Mobile devices include, for example, IPHONES (available from Apple Inc., Cupertino, Calif.), BLACKBERRY devices (available from Research in Motion, Waterloo, Ontario, Canada), or any smart phones equipped with the ANDROID platform (available from Google Inc., Mountain View, Calif.), tablets, such as the IPAD and KINDLE FIRE, and personal digital assistants (PDAs).

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. In addition, the terms like “consumer equipment,” “mobile station,” “mobile,” “communication device,” “access terminal,” “terminal,” “handset,” and similar terminology, refer to a wireless device (e.g., cellular phone, smart phone, computer, PDA, set-top box, Internet Protocol Television (IPTV), electronic gaming device, printer, and so forth) utilized by a consumer of a wireless communication service to receive or convey data, control, voice, video, sound, gaming, or substantially any data-stream or signaling-stream. The foregoing terms are utilized interchangeably in the subject specification and related drawings. The terms “component,” “system,” “platform,” “module,” and the like refer broadly to a computer-related entity or an entity related to an operational machine with one or more specific functionalities. Such entities can be hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 is a block diagram of an exemplary network in accordance with an embodiment of the invention;

FIGS. 2A, 2B, and 2C are block diagrams of an exemplary consumer device, merchant system, and transaction server, respectively, in accordance with an embodiment of the invention;

FIG. 3 depicts an exemplary method for performing two-factor authentication for payment transactions in accordance with an embodiment of the invention; and

FIGS. 4A and 4B illustrate the performance of two-factor authentication for payment transactions in accordance with different embodiments of the invention.

### DETAILED DESCRIPTION

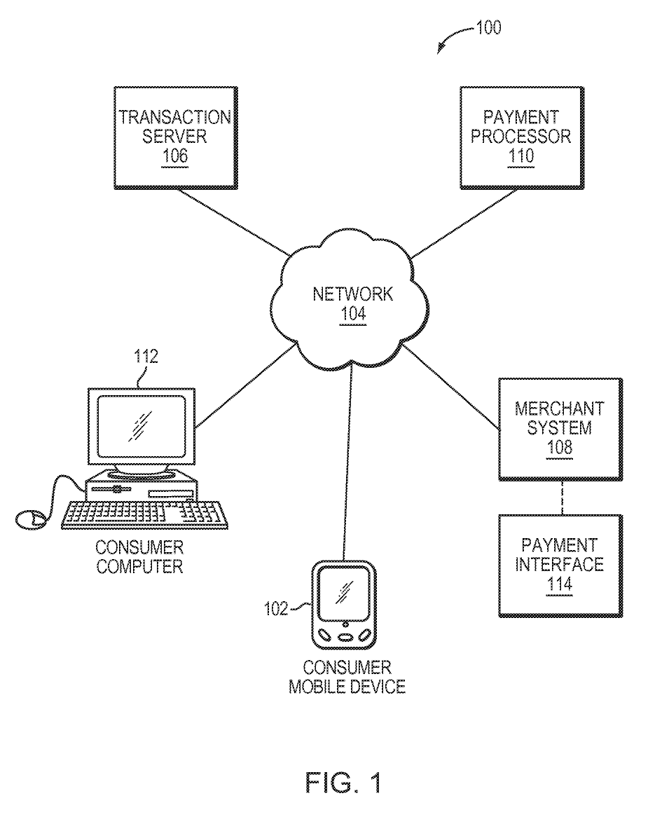

Refer first to FIG. 1, which depicts an exemplary two-factor authentication network 100 including a consumer device (e.g., a mobile device) 102 linked to a network 104 (e.g., a cellular telephone network, the Internet, or any wide-area network or combination of networks capable of supporting point-to-point data transfer and communication) that supports wired, wireless, or any two-way communication. The network 104 connects various devices, including a transaction server 106, one or more merchant systems 108, a payment processor 110, and a consumer computer 112 utilizing, again, wired, wireless, or any two-way communications. Each merchant system 108 may be associated with a merchant who offers goods or services for sale to, among others, the consumer possessing the mobile device 102. In one embodiment, the merchant system 108 is a POS terminal (e.g., an electronic cash register) that connects to a payment interface console 114. Alternatively, the merchant system 108 may be an online shopping website displaying a payment interface 114 upon “check-out.” The payment interface 114 is capable of accepting input from the consumer selecting a payment method and providing an account identifier (e.g., an email address or phone number), and making the information available to the merchant system 108. In addition, the payment interface 114 may be mobile or physically associated with the merchant system 108.

The merchant system 108 transmits the provided identifier and transaction details to the transaction server 106 to request authorization for a payment transaction. The transaction server 106 is responsible for facilitating payment transactions between a merchant and a consumer by routing authorization requests, and subsequent approvals, between the merchant system 108, the consumer's mobile device 102, and the payment processor 110. The payment processor 110 may be responsible for actually performing the payment transaction. For example, a so-called “direct” payment processor acts as the financial-processing “backend” provider to credit-card issuers and payment services. An “indirect” payment processor is an independent entity processing transactions for multiple payment services and maintains its own records and data.

Where the merchant is an online shopping website, the consumer computer 112 acts as a gateway for the consumer to select items and make purchases. The computer 112 may be any device supporting at least one communication channel for exchanging HTML and other data with the network 104 and the merchant system 108 using, for example, a Wi-Fi LAN (e.g., IEEE 802.11 standard) or other Internet access gateway. For example, the computer 112 may be a personal computer, laptop, tablet, or smartphone. In one embodiment, the mobile device 102 may also assume the role of the consumer computer 112.

The mobile device 102 enables the consumer to communicate with the payment processor 110, and although for simplicity this communication is shown as supported by the network 104, data ideally transits via a communication channel different from that utilized by the computer 112; for example, while the devices 102, 112 may both communicate via the Internet, the computer 112 may access it via a LAN and the mobile device 102 via the public telecommunications infrastructure.

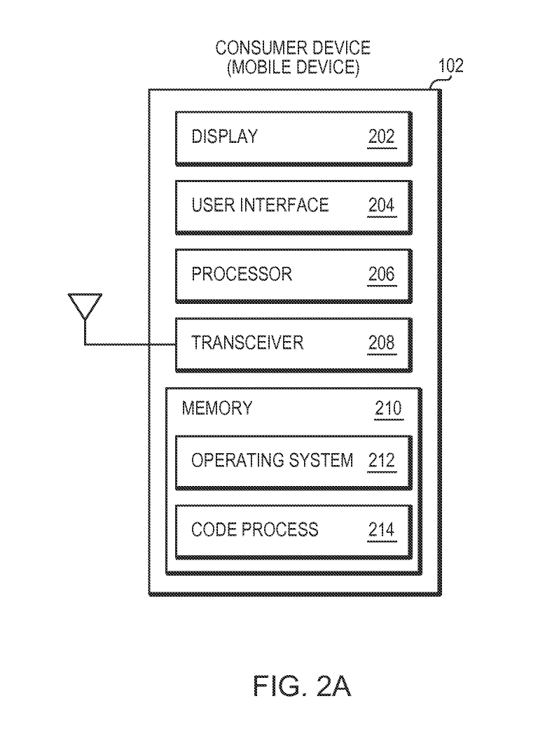

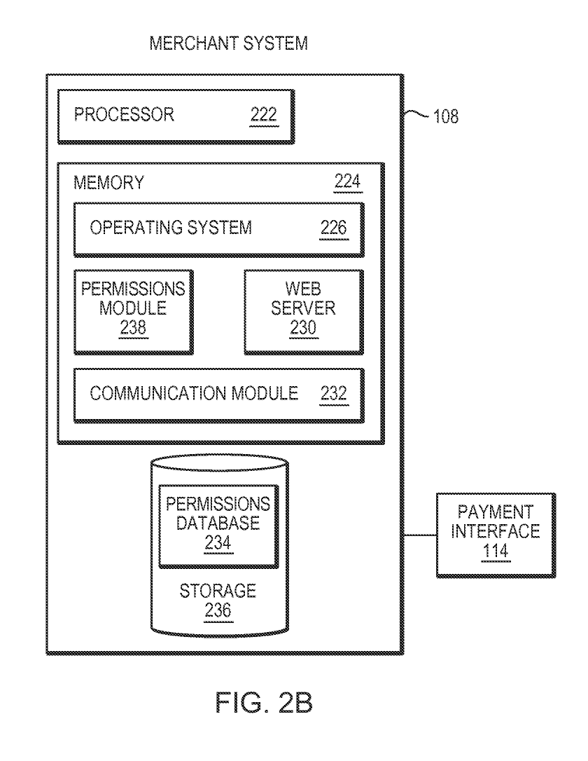

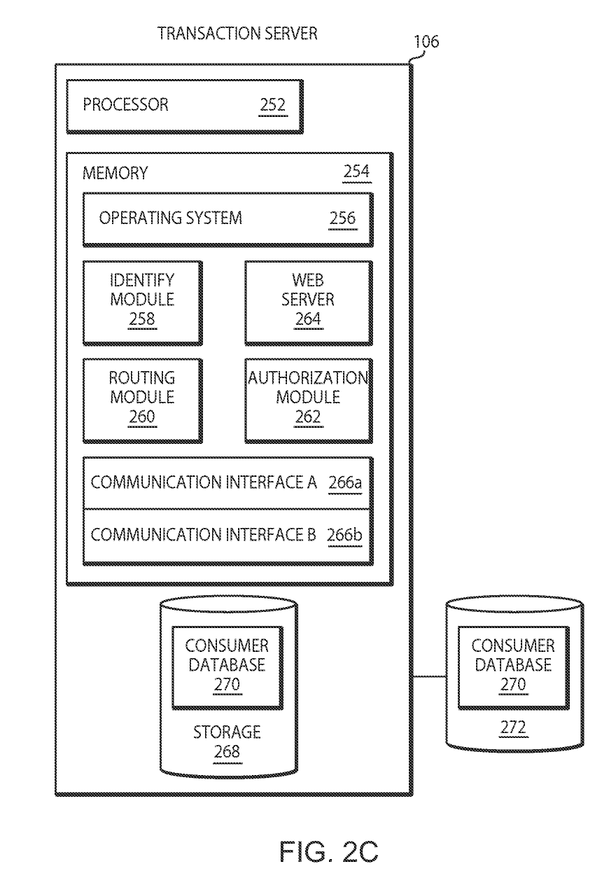

Referring to FIG. 2A, in various embodiments, the mobile device 102 includes a conventional display screen 202, a user interface 204, a processor 206, a transceiver 208, and a memory 210. The transceiver 208 may be a conventional component (e.g., a network interface or transceiver) designed to provide communications with a network, such as the Internet and/or any other land-based or wireless telecommunications network or system, and, through the network, with the payment processor 110. The memory 210 includes an operating system (OS) 212, such as GOOGLE ANDROID, NOKIA SYMBIAN, BLACKBERRY RIM or MICROSOFT WINDOWS MOBILE, and a code process 214 that implements the device-side functions as further described below. Additional transaction-related or identifying information may be embedded in the code process 214 for transmission through the network 104 for later processing on a back-end server (e.g., the transaction server 106). The memory 210 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit.

Referring to FIG. 2B, in various embodiments, the merchant system 108 includes a processor 222 and a memory 224, which may include volatile and non-volatile portions. The memory 224 contains instructions, conceptually illustrated as a group of modules, that control the operation of the processor 222 and its interaction with hardware components. An operating system 226 directs the execution of low-level, basic system functions such as memory allocation, file management and operation of mass storage devices. At a higher level, a permissions module 228, a web server block 230, and a communication module 232 perform the basic system functions described in greater detail below. The communication module 232 may be a conventional component (e.g., a network interface or transceiver) designed to provide communications with a network, such as the Internet and/or any other land-based or wireless telecommunications network or system, and, through the network, with the transaction server 106, the consumer computer 112, the payment interface 114 and, in some embodiments, the payment processor 110. The web-server block 230 enables web-based communication with the payment interface 114 and the consumer computer 112, and can be a conventional web-server application executed by the processor 222.

With reference to FIGS. 1 and 2B, the merchant system 108 may be connected to or include the payment interface 114, which is capable of accepting input from the consumer selecting a payment method and providing an account identifier (e.g., an email address or phone number). When the transaction server 106 is selected to support payment, the permissions module 228 is responsible for generating and transmitting to the server 106 an authorization request that includes the identifier provided by the consumer and the transaction details. The transaction details may be a one-time immediate payment transaction, or a recurring payment transaction. Additionally, the permissions module 228 may receive, by way of the communication module 232, authorization from the transaction processor 106 responsive to the request; details regarding the authorization may be saved in a permissions database 234, located in a mass storage device 236, for retrieval in subsequent transactions with the consumer. The records in the database 234 may contain granted permissions with an associated consumer identifier. In some embodiments, the permissions granted may be encrypted and/or in the form of a token received from the transaction server 106. In one embodiment, in which the permissions include authorization for recurring payment transactions, the merchant system 108 may communicate directly with a back-end server (e.g., the payment processor 110) in subsequent payment transactions. Accordingly, the merchant system 108 does not require secure information from the consumer to process a payment transaction.

The transaction server 106 is a trusted system that facilitates a payment transaction between the merchant and a registered consumer. In response to a request made by a merchant system 108 for a transaction authorization, the transaction server 106 routes the request to the user via mobile device 102 for approval, and communicates the result back to the merchant system 108. In one embodiment, the transaction server 106 saves granted permissions to verify authorization of transaction requests from the merchant system 108 without communication with the mobile device 102. Additionally, the transaction server 106 may process an authorized transaction with the payment processor 110.

Referring to FIG. 2C, in various embodiments the transaction server 106 includes a processor 252, a memory 254, an operating system 256, an identity module 258, a routing module 260, an authorization module 262, a web server block 264, a first communication interface 266a, a second communication interface 266b, and a storage device 268. As described above, the various functional modules are typically implemented as stored instructions that operate as running processes via the processor 252. The communication interface A 266a and communication interface B 266b may be conventional components designed to provide communications with a network, and, through the network over at least two different communication channels (a first communication channel and a second communication channel respectively), with the mobile device 102, the merchant system 108, and the payment processor 110. The web-server block 264 enables web-based communication with the mobile device 102, and can be a conventional web-server application executed by the processor 252. A consumer database 270 may reside in the storage device 268 and/or in an external mass-storage device 272 accessible to the transaction server 106; the consumer database 270 stores, for example, a record for each registered consumer with log-in information, an associated registered mobile device 102, a unique identifier (e.g., email address or phone number), and funding source(s). The database 270 is responsive to queries from the identity module 258.

In operation, the transaction server 106 receives over a first communication channel, by way of the communication interface 266a, a request made by the merchant system 108 to authorize payment transactions with a registered consumer. The request contains at least information identifying the consumer and transaction details. The identity module 258 obtains the consumer's account records from the consumer database 270 and verifies that the account is in good standing. The routing module 260 selects the communication interface 266b to transmit over a second communication channel different from the first communication channel an authorization request to the mobile device 102 registered to the consumer and upon, receiving a response from the mobile device 102 indicating the consumer's approval, selects the communication interface 266a to transmit over the first communication channel the granted permissions to the merchant system 108 originating the request. Additionally, the identity module 258 saves the granted permissions to consumer's record in the consumer database 270. In one embodiment, the authorization module 262 encrypts the permissions and/or converts them to token form prior to transmission. The granted permissions may authorize the merchant system 108 various levels of approval for charging the consumer's account in subsequent transactions i.e., submitting payment requests directly to the payment processor 110 without individual authorizations from the consumer. In this embodiment, the authorization request from the merchant system 108 may include the granted permissions or token along with the transaction details. The authorization module 262 to verifies that the transaction complies with the granted permissions, and upon verification, may submit the transaction to the payment processor 110 without additional approval needed from the consumer. Additionally, the consumer may log into in the transaction server 106 to alter any granted permissions associated with her account record within the consumer database 270; the routing module 260 in turn selects an appropriate communication channel to transmit the altered permissions to the merchant systems 108.

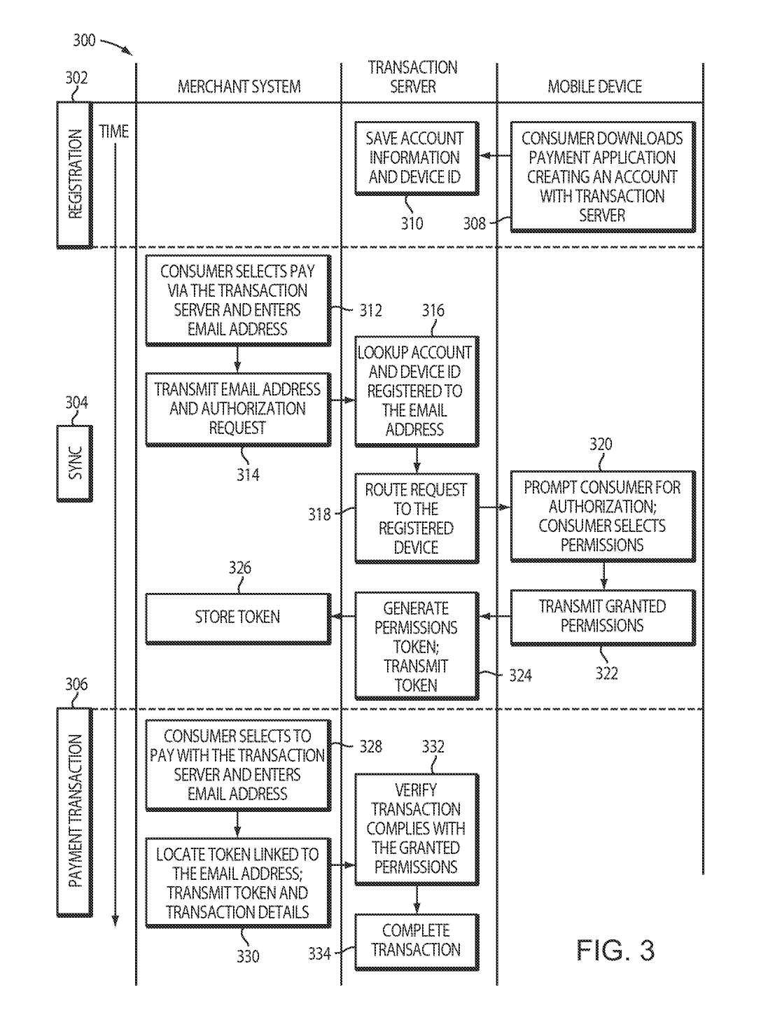

A representative workflow 300 consistent with embodiments of the current invention is shown in FIG. 3. The workflow may involve different stages that need not take place in tandem or at specific times: a consumer registration stage 302, a synchronization (“sync”) stage 304, and a payment transaction stage 306.

The consumer creates an account with payment transaction server 106 to enable the transaction server 106 to facilitate secure payment transactions with a third party, such as the merchant system 108. In the registration stage 302, the consumer may download an application (“app”) provided by the transaction server 106 to her mobile device 102; running the app enables the consumer to create an account with the server 106. During account setup, the consumer provides log-in information (e.g., a username/password combination), a unique identifier (e.g., an email address), and at least one financial funding source. Additionally, the mobile device 102 on which the app is downloaded is linked to the consumer's account (step 308). In one embodiment, the consumer may provide more than one funding source and define parameters of use for the multiple funding sources. For example, the user may designate her checking account to be charged for transactions under a specific amount, while designating a credit card account for all other transactions. With reference to FIGS. 1 through 3, the identity module 258 of the transaction server 106 processes the provided information and saves a record of the new consumer with the associated account information to the consumer database 270 (step 310).

At any time after registration, the consumer may wish to grant one or more merchants various levels of permission to charge her account; this occurs at the sync stage 304. Assuming that the merchant system 108 also has an account with the transaction server 106, the consumer may set up payment permissions with the system 108 (via at the payment interface 114) by selecting the payment option corresponding to the transaction server 106 and providing an email address registered to her account (step 312). The permissions module 228 of the merchant system 108 communicates over a first communication channel the authorization request to the transaction server 106; the request contains the provided email address along with its own identifying information (step 314). When the request is received by transaction server 106, the identity module 258 locates the consumer's account information within the consumer database 270 (step 316), and the routing module 260 selects a second communication channel different from the first channel over which the request from the merchant was received and transmits the request to the mobile device 102 registered to the consumer's account (step 318). A push notification is then sent to the application (downloaded during account setup) on her registered mobile device 102. The application downloaded to the device 102 will display a dialog prompting the consumer to approve or deny the request (step 320). Additionally, she may be prompted at this time to select from a series of permission levels ranging from “charge me once” to “charge me at any time.” The app executes a script that transmits, over the same communication channel as the request from the server 106 was received, the consumer's selected authorization as well as information authenticating the phone to the transaction server 106 (step 322). The identity module 258 may save these permissions to the consumer's record in the consumer database 270 while the routing module 260 may transmit over the first communication channel the granted permissions to merchant system 108. In one embodiment, the authorization module 262 converts the permissions to a token before they are saved and transmitted (step 324). The merchant system 208 saves the received permissions or token to the permissions database 234 for use in subsequent transactions with the consumer (step 326). Additionally, the consumer, or an application acting on behalf of the consumer, may manage these permissions by logging in to the server 106 at any time to modify or revoke the authorized permissions; the routing module 260 in turn communicates the modified or revoked permissions to the merchant system 108. Accordingly, the consumer may sync her account with more than one merchant system 108, and may manage the granted permission levels at any given time.

In the payment transaction stage 306, the consumer purchases goods or services from the merchant. For example, the consumer may have previously authorized permissions as described above in the sync stage 304. Alternatively, the steps described above in connection with the sync stage 302 may be carried out in tandem with the steps that occur, as described below, during the payment transaction stage 306. The consumer selects goods or services to purchase from the merchant and upon check-out selects the payment option corresponding to the transaction server 106 presented to her on the payment interface 114 of the merchant system 108. The consumer is prompted for identifying information, e.g., an email address or phone number (step 328), and the permissions module 228 of the merchant system 108 looks up the consumer's information in the permissions database 234, locating the saved permissions or token if the consumer has previously synchronized her account.

If the consumer's information is not found in the database 234, the authorization steps described in the sync stage 304 are carried out. If the consumer's information is found, the permissions or token and the transaction details are transmitted to the transaction server 106 (step 330). The authorization module 262 verifies that transaction details comply with the authorized permissions (step 332) and completes the transaction with the payment processor 110 (step 334). In one embodiment, the authorization module 262 may simply deny the transaction if it does not comply with the authorized permissions. Alternatively, the authorization module 262 may trigger the identity module 258 to locate the consumer's record in the consumer database 270 and the routing module 260 may route the un-authorized transaction details to the consumer's registered mobile device 102, prompting the consumer to approve or deny the transaction as described in above in the sync stage 304. The transaction server 106 communicates the response to the merchant system 108 and, if authorization is granted, completes the transaction with the payment processor 110. In an alternate embodiment, the merchant system 108 transmits the granted permissions or token along with the transaction details directly to the payment processor 110 for processing, and the processor 110 is configured to analyze the permissions or token against the transaction details to verify that the transaction is authorized before processing.

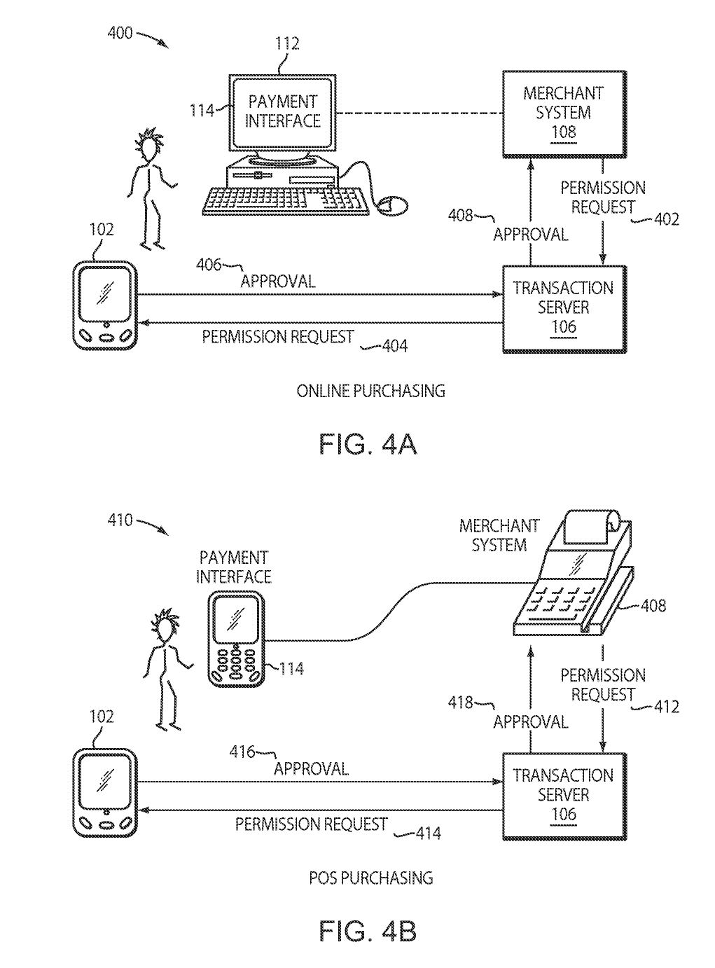

As illustrated in FIG. 4A, the consumer may use the transaction server 106 to facilitate payment for goods or services purchased at an online shopping website (merchant system 108) in a representative embodiment 400. The consumer visits a shopping website, selects items for purchase, and proceeds to check out, selecting the payment option corresponding to the transaction server 106. The merchant system 108 sends over a first communication channel a request for approval to the transaction server 106 (step 402), which communicates over a second communication channel with the consumer's registered mobile device 102 requesting authorization for the transaction (step 404). The consumer manifests approval by, e.g., touching an “approval” button displayed on the device 102. An app (downloaded during set-up) on the phone executes a script that confirms over the second communication channel the consumer's selection of the approval button as well as information authenticating the phone with the transaction server 106 (step 406), which in turn communicates over the first communication channel approval to the merchant system 108 (step 408).

Alternatively, as illustrated in FIG. 4B, the consumer may also use the transaction server 106 to purchase goods or services by paying at a POS payment terminal (i.e., merchant system 108), which offers the consumer the choice of selecting debit card swipe, credit card swipe, or transaction server 106. If the consumer selects the payment option corresponding to the transaction server 106, the payment terminal (merchant system 108) sends over a first communication channel an authorization request to the transaction server 106 (step 412), which communicates over a second communication channel with consumer's registered mobile device 102 requesting approval (step 414). The consumer manifests approval by, e.g., touching an “approval” button displayed on the device 102. An app on the phone executes a script that confirms over the second communication channel the consumer's selection of the approval button as well as information authenticating the phone with the transaction server 106 (step 416), which in turn communicates over the first communication channel approval to the merchant system 108, i.e., the POS terminal (step 418).

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. For example, each of the processors described herein may be a general-purpose computer, but alternatively may be a CSIC (consumer-specific integrated circuit), ASIC (application-specific integrated circuit), a logic circuit, a digital signal processor, a programmable logic device, such as an FPGA (field-programmable gate array), PLD (programmable logic device), PLA (programmable logic array), RFID processor, smart chip, or any other device or arrangement of devices that is capable of implementing the steps of the processes of the invention.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The various modules and apps described herein can include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of authorizing a payment transaction among a consumer, a merchant, and a registered consumer device by a transaction server, the method comprising:
transmitting, by a merchant system to the transaction server over a first communication channel, a transaction-authorization request containing a consumer identifier but not including secure information of the consumer;
subsequent to the communication from the merchant system and without initiation by the consumer, transmitting the transaction authorization request to the registered consumer device over a second communication channel different from the first communication channel; and
upon receiving over the second communication channel a transaction authorization, which does not include secure consumer information, granted by the consumer via the registered device, transmitting the transaction authorization to the merchant system over the first communication channel.

2. The method of claim 1 wherein the transaction authorization includes a permission for a single payment transaction with the merchant.

3. The method of claim 1 wherein the transaction authorization includes a permission to process a plurality of payment transactions with the merchant.

4. The method of claim 3 wherein the permission is for only transactions meeting at least one criterion defined by the consumer.

5. The method of claim 1 wherein the transaction authorization is in the form of a token.

6. The method of claim 1 wherein the consumer identifier is an email address.

7. The method of claim 1 wherein the consumer identifier is a phone number.

8. The method of claim 1 further comprising storing the transaction authorization in a first transaction with the consumer for authorization in a subsequent transaction with the consumer.

9. The method of claim 1 further comprising:
modifying the transaction authorization via the registered consumer device in communication with the transaction server over the second communication channel; and
transmitting, by the transaction server, the modified authorization to the merchant system over the first communication channel.

10. The method of claim 1 wherein the first communication channel is the Internet and the second communication channel is a wireless telephone connection.

11. A transaction server for authorizing a payment transaction among a consumer, a merchant, and a registered consumer device, the server comprising:
a first interface for communicating over a first communication channel for receiving, from a merchant server, a transaction authorization request containing a consumer identifier, the consumer identifier not including secure information of the consumer;
a second interface for communicating over a second communication channel different from the first communication channel; and
a processor configured to (i) identify the consumer based on the consumer identifier and without using secure information of the consumer, (ii) transmit the transaction authorization request to the registered consumer device over the second communication channel via the second interface without initiation by the consumer, and (iii) transmit the transaction authorization to the merchant system over the first communication channel via the first interface upon receiving, over the second communication channel via the second interface, a transaction authorization, which does not include secure consumer information, granted by the consumer via the registered consumer device.

12. The system of claim 11 wherein the transaction authorization includes a permission for a single payment transaction with the merchant.

13. The system of claim 11 wherein the transaction authorization includes a permission to process subsequent payment transactions with the merchant.

14. The system of claim 13 further comprising a permissions database for storing consumer permissions, the permission to process subsequent payment transactions with the merchant being application only to transactions meeting criteria defined by the consumer and stored in a record of the database.

15. The system of claim 11 wherein the first communication channel is the Internet and the second communication channel is a wireless telephone connection.
